(19) United States
(12) Patent Application Publication
(10) Pub. No.: US 2007/0197100 A1
(43) Pub. Date: Aug. 23, 2007

(54) Type of hard disk interface device

(76) Inventor: Robert Tsao, Taipei City (TW)

Correspondence Address: SCHMEISER, OLSEN & WATTS, 22 CENTURY HILL DRIVE, SUITE 302, LATHAM, NY, 12110, US

(21) Appl. No.: 11/356,782

(22) Filed: Feb. 17, 2006

(51) Int. Cl. H01R 33/00

(52) U.S. Cl. 439/638

(57) ABSTRACT

This invention relates to a type of hard disk interface device, comprising a control circuit, at least one first hard disk connector, at least one second hard disk connector, and at least one removable adaptor, wherein the control circuit comprises a USB interface, such that the control circuit can be connected to a main computer unit by means of the USB interface, and the first hard disk connector is connected to the control circuit, and is based on the SATA standard, while the second hard disk connector is based on the IDE standard, and it is also connected to the control circuit, and the hard disk adaptor can be attached to the second hard disk connector to be used for the hard disk drive (or CD-ROM) of different sizes, and when a hard disk interface device is used with a main computer unit, the main computer unit can be connected to different types of hard disk drives, in order to retrieve and store different types of hard disk data.

### TECHNICAL FIELD

This invention relates to a type of hard disk interface device, particularly a type of hard disk interface device that has multiple protocols, and which can be used with a main computer unit to allow the main computer unit to be connected to different types of hard disk drives, in order to retrieve and store different types of hard disk data.

### BACKGROUND OF THE INVENTION

The general widely-used hard disk interface devices make use of the Integrated Device Electronics (IDE) standard, and they are used with main computer units to enable the main computer units to be connected to IDE hard disk drives (or CD-ROMs), in order to retrieve and store data from the hard disk drives (or CD-ROMs).

Nevertheless, Serial Advanced Technology Attachment (SATA) hard disk drives have currently been developed, and they allow for faster data transfer and easier connection and have smaller connection heads. Consequently, the single-standard hard disk interface devices are limited to use with only one type of hard disk drive, and are unable to meet the requirements of use with different types of hard disk drives (or CD-ROMs).

### SUMMARY OF INVENTION

With regards to the aforesaid weaknesses in the commonly-used hard disk interface devices, the present inventor has acquired manufacturing experience and technology accumulation in relation to various types of hard disk interface devices, and has carefully investigated many possible solutions to the aforesaid weaknesses, and following unceasing investigations, practical tests and improvements, he finally designed the type of hard disk interface device in the present invention.

The objective of the present invention is to provide a type of hard disk interface device, which will be compatible for connecting different types of hard disks with various different protocols.

Based on the aforesaid objective, the hard disk interface device comprises a control circuit, at least one first hard disk connector, at least one second hard disk connector, and at least one removable adaptor, wherein the control circuit comprises a USB interface, such that the control circuit can be connected to a main computer unit by means of the USB interface, and the first hard disk connector is connected to the control circuit, in order to enable a connection to be established with the SATA hard disk drive, while the second hard disk connector is based on the IDE standard, and it is also connected to the control circuit, in order to enable a connection to be established with the IDE hard disk drive, and the hard disk adaptor can be attached to the second hard disk connector to be used for the hard disk drive (or CD-ROM) of different sizes, and when a hard disk interface device is used with a main computer unit, the main computer unit can be connected to different types of hard disk drives, in order to retrieve and store different types of hard disk data, thereby increasing the scope of use for different types of hard disk drives, and reducing the capital costs for interface devices.

### BRIEF DESCRIPTION OF DRAWINGS

The invention will be more clearly understood after referring to the following detailed description read in conjunction with the drawings wherein:

FIG. 1 refers to the block schematic diagram of the interface device of the present invention.

FIG. 2 refers to block schematic diagram of the direct current supply of the present invention.

FIG. 3 refers to the three-dimensional diagram of the external appearance of the interface device of the present invention.

### DETAILED DESCRIPTION OF PREFERRED EMBODIMENTS

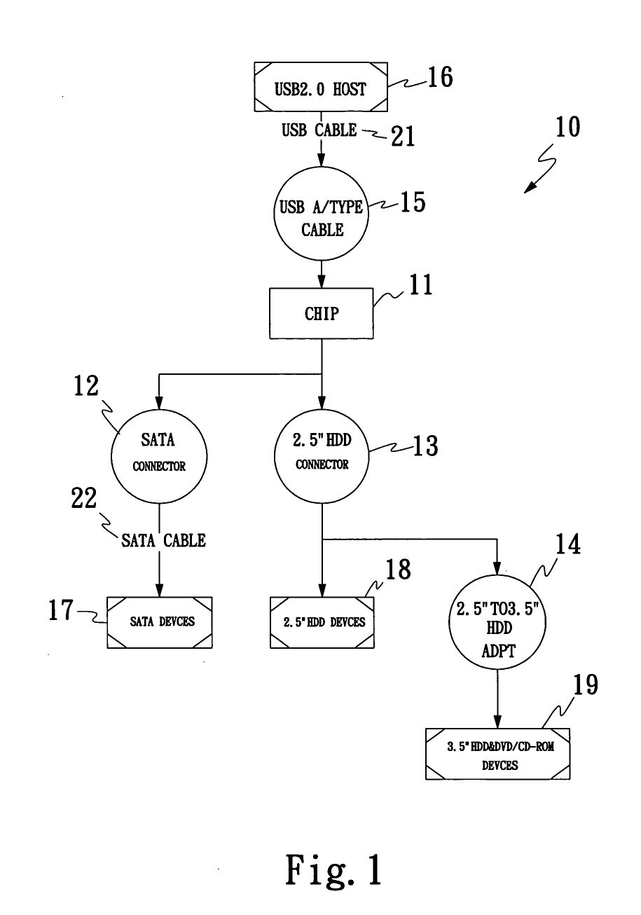

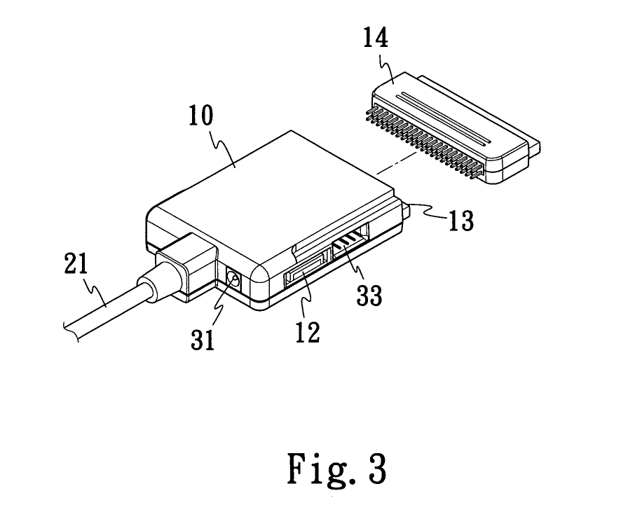

The present invention relates to a type of hard disk interface device. It can be seen from FIGS. 1 and 3 that the hard disk interface device (10) mainly comprises a control circuit (1), at least one first hard disk connector (12), at least one second hard disk connector (13), and at least one removable adaptor (14).

The control circuit (11) comprises a USB interface (15), such that the control circuit can be connected to a main computer unit (16) by means of the USB interface (15), and the first hard disk connector (12) is connected to the control circuit (11), whose series is SATA, in order to enable a connection to be established with the SATA hard disk drive (17), while the second hard disk connector (13) is based on the IDE standard, and it is also connected to the control circuit (11), in order to enable a connection to be established with the IDE hard disk drive (18), and the removable adaptor (14) can be attached to the second hard disk connector (13) to be used for the hard disk drive (or CD-ROM) of different sizes (19).

Based on the aforesaid organization of the components, when a hard disk interface device (10) is used with a main computer unit (16), the main computer unit (16) can be connected to different types of hard disk drives, in order to retrieve and store different types of hard disk data, thereby increasing the scope of use for different types of hard disk drives, and reducing the capital costs for interface devices.

It can be seen from FIGS. 1 and 3 that the USB interface (15) is electrically connected to the main computer unit (16) through a USB cable (21).

It can be seen from FIGS. 1 and 3 that the SATA hard disk drive (17) is electrically connected to the first hard disk connector (12) through a SATA cable (22).

It can be seen from FIG. 1 that the second hard disk connector (13) is a 2.5-inch IDE hard disk connector, and can be adapted for a 3.5-inch IDE hard disk or CD-ROM connector by means of a removable adaptor (14), or the second hard disk connector (13) is a 3.5-inch IDE hard disk or CD-ROM connector, and can be adapted for a 2.5-inch IDE hard disk connector by means of a removable adaptor (14).

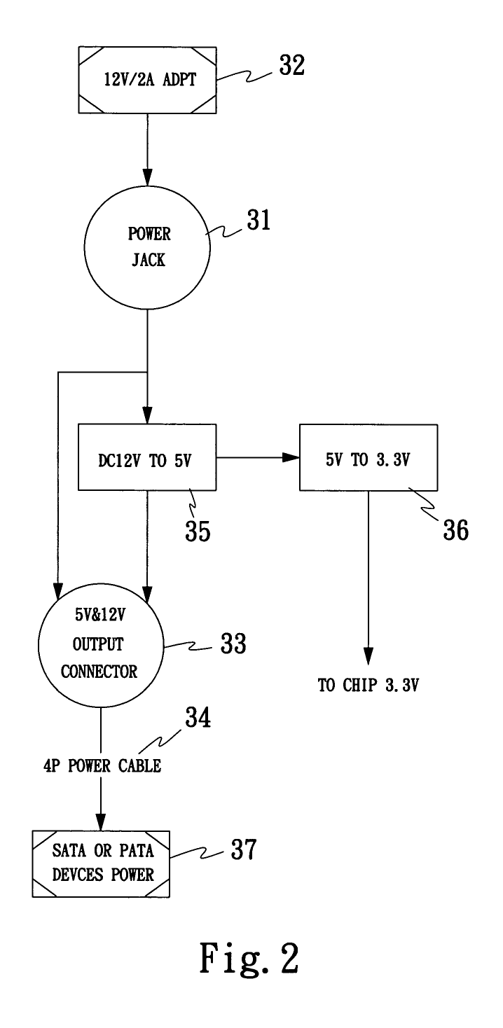

It can be seen from FIGS. 2 and 3 that the hard disk interface device (10) has a power input (31) (in the present invention, the power input (31) can be a power jack), and a 12V/2 A transformer (32) is connected to the power input (31), and power supply is carried out. The hard disk interface device (10) also has a power output (33) (in the present invention, the power output (33) can be a 4 P power output socket), enabling the externally connected hard disk drive to be connected to the power output (33) by means of a 4 P power cable (34).

When the supply of power is carried out, a power converter (35) of the hard disk interface device (10) can convert the power (DC 12V/2 A) in the transformer (32) to DC 5V, and then supply the control circuit (11) with the required 3.3V actuating power (36), and at the same time supply DC 5V and DC 12V power (37) to the SATA device or IDE-PATA device through the 4 P power cable (34), thereby achieving the performance of providing external power in order to actuate multiple or new-model high-energy-consumption hard drives.

Summarizing the aforesaid, the hard disk interface device of the present invention has a novel structure that has not existed before, and has not been published before in any publications, and similar products have not been seen in the market. Undoubtedly, it has novel features. In addition, the unique characteristics and performance of the present invention are unmatched by commonly-used devices, and the present invention is therefore an improvement on the commonly-used devices, and meets the requirements of patentability according to the laws of this country. A claim is made to register the present invention as a patent in accordance to the law.

The aforesaid description is the preferred embodiment in the present invention, but it does not limit the scope of the embodiments for the present invention, and anybody who is well-versed with the technology can easily make any changes or adjustments to the present invention based on the scope of the present invention, and within the scope laid out in the patent.

Explanation Of Main Components

10: Hard disk interface device
11: Control circuit
12: First hard disk connector
13: Second hard disk connector
14: Removable adaptor
15: Universal Serial Bus (USB) interface
16: Main computer unit
17: Serial Advanced Technology Development (SATA) hard disk drive
18: Integrated Drive Electronics (IDE) hard disk drive
19: Hard disk drive (or CD-ROM) of different sizes
21: USB cable
22: Serial Advanced Technology Development (SATA) cable
31: Power input
32: 12V/2 A transformer
33: Power output
34: 4 P power cable
35: Power converter
36: 3.3V actuating power
37: DC 5V and DC 12V power

1. A type of hard disk interface device, comprising:
a control circuit, wherein the control circuit comprises a universal serial bus (USB) interface, such that the control circuit can be connected to a main computer unit;
at least one first hard disk connector, wherein a serial advanced technology development (SATA) standard is used, and wherein the at least one first hard disk connector is connected to the control circuit;
at least one second connector connected to the control circuit.

2. A type of hard disk interface device referred to in claim 1, wherein the at least one second connector has an integrated drive electronics (IDE) standard, wherein the hard disk connector is connected to the control circuit, and wherein the second hard disk connector is a 2.5-inch IDE hard disk connector, and can be adapted for a 3.5-inch IDE hard disk by means of a removable adaptor.

3. A type of hard disk interface device referred to in claim 1, wherein the at least one second connector has an integrated drive electronics (IDE) standard wherein the hard disk connector is connected to the control circuit, and wherein the second hard disk connector is a 3.5-inch IDE hard disk, and can be adapted for a 2.5-inch IDE hard disk connector by means of a removable adaptor.

4. A type of hard disk interface device referred to in claim 1, further comprising:
a power output, in order to supply direct current to the control circuit.

5. A type of hard disk interface device referred to in claim 1, wherein the power output actuates at least one hard disk.

6. A type of hard disk interface device referred to in claim 1, further comprising:
at least one second hard disk connector, wherein the integrated drive electronics (IDE) standard is used, and the hard disk connector is connected to the control circuit.

7. A type of hard disk interface device referred to in claim 1, wherein the at least one second connector has an integrated drive electronics (IDE) standard.

8. A type of hard disk interface device referred to in claim 1, wherein the at least one second connector is a compact disk-read only memory (CD-ROM) connector.

9. A device comprising:
a control circuit having a universal serial bus (USB) interface wherein the control circuit can be connected to a main computer unit;
a first hard disk connector configured to a serial advanced technology development (SATA) standard, wherein the hard disk connector is connected to the control circuit; and
a second hard disk connector configured to an integrated drive electronics (IDE) standard, wherein the hard disk connector is connected to the control circuit.

10. The device of claim 9, further comprising:
a removable adaptor, wherein the second hard disk connector is configured as a 2.5-inch IDE hard disk connector, and wherein said removable adapter is configured for a 3.5-inch IDE hard disk.

11. The device of claim 9, further comprising:
a removable adaptor, wherein the second hard disk connector is configured as a 2.5-inch IDE hard disk connector, and wherein said removable adapter is configured for a compact disk-read only memory (CD-ROM).

12. The device of claim 9, further comprising:
a removable adaptor, wherein the second hard disk connector is configured as a 3.5-inch IDE hard disk connector, and wherein said removable adapter is configured for a 2.5-inch IDE hard disk connector.

13. The device of claim 9, further comprising:
a removable adaptor, wherein the second hard disk connector is configured as a 3.5-inch IDE hard disk connector, and wherein said removable adapter is configured for a CD-ROM.

14. The device of claim 9 further comprising:
a power output, in order to supply direct current to the control circuit and actuate at least one hard disk.

15. An interface device comprising:
a control circuit having a USB interface, such that the control circuit can be connected to a main computer unit;
a first hard disk connector having a serial advanced technology development (SATA) standard connected to the control circuit;
a second hard disk connector having an integrated drive electronics (IDE) standard connected to the control circuit;
at least one removable adaptor, wherein the removable adaptor can be connected to the second hard disk connector, in order to be used for a different sized IDE standard connector; and
a power output, in order to supply direct current to the control circuit and actuate at least one hard disk.

16. The interface device of claim 15, wherein the second hard disk connector is a 2.5-inch IDE hard disk connector, and can be adapted for a 3.5-inch IDE hard disk connector by means of the removable adaptor.

17. The interface device of claim 15, wherein the second hard disk connector is a 3.5-inch IDE hard disk or a compact disk-read only memory (CD-ROM) connector, and can be adapted for a 2.5-inch IDE hard disk connector by means of a removable adaptor.

18. The interface device of claim 15, wherein the second hard disk connector is a a compact disk-read only memory (CD-ROM) connector, and can be adapted for a 2.5-inch IDE hard disk connector by means of a removable adaptor.

19. The interface device of claim 15, wherein the power output is configured as a 4 P power output socket.

20. The interface device of claim 15 further comprising:
a 12 volt adapter;
a power jack connected to the control circuit, wherein the 12 volt adaptor is releasably connected to the power jack; and
a power converter, wherein the power converter has an output of 3.3V, 5V and 12V.
